(19) United States
(12) Patent Application Publication
(10) Pub. No.: US 2012/0213472 A1
(43) Pub. Date: Aug. 23, 2012

(54) FIBER BUNDLE BASED PASSIVE BI-DIRECTIONAL OFF-AXIS FORJ WITH CENTER BORE

(76) Inventors: Louis D. VIOLANTE, Monroe Township, NJ (US); Boying B. ZHANG, Lawrenceville, NJ (US); Hong ZHANG, North Brunswick, NJ (US)

(21) Appl. No.: 13/029,377

(22) Filed: Feb. 17, 2011

(51) Int. Cl. G02B 6/26

(52) U.S. Cl. 385/26

(57) ABSTRACT

A Passive Bi-Directional Off-Axis Fiber Optic Rotary Joint (FORJ) with a center bore has been invented in which an optical signal can be transmitted across a rotating boundary without using the centerline or axis of rotation of the FORJ. Rather a fiber bundle is used to transmit the optical signal across a single mechanical rotational interface.

### BACKGROUND OF THE INVENTION

A typical passive Fiber Optic Rotary Joint (FORJ) consists of a fixed collimator holder and a rotatable collimator holder, which are relatively rotatable with respect to each other allowing the uninterrupted transmission of an optical signal through the rotational interface from collimators on any one of the holders to the collimators on another holder using the centerline or axis of rotation. This causes a problem when the centerline or axis of rotation is required for other purposes, such as passing fluid, or a rotational shaft.

In an effort to address this problem traditional off-axis FORJs have either relied on a complex array of mirrors or they had to be active. Both of these configurations had their drawbacks. A complex mirror array, while passive, had a relatively long optical path reducing the overall stability of the structure. The active off-axis devices relies on diode to convert the optical signal into an electric signal then used a traditional electric slip ring to transmit the signal across the rotary interface then use a laser to convert the electric signal back into an optical signal. This configuration requires power to operate, unlike a passive device, and is significantly heavy then a passive counterpart.

Princetel, Inc. has demonstrated the use of a fiber bundle to pass an optical signal across a single mechanical Rotary Interface for use in a passive on-axis FORJ (U.S. Pat. No. 7,881,569). In this configuration a number of small core optical fibers are circumferentially arranged around the first channel resulting in a blind spot free second channel.

### SUMMARY OF THE INVENTION

The object of the present invention utilizes a fiber bundle to transmit the optical signal across a single mechanical rotational interface without the using the centerline or axis of rotation of the FORJ while maintaining a very low profile and compact structure.

### BRIEF DESCRIPTION OF THE DRAWINGS

FIG. 1—Is the mechanical embodiment of the first configuration for the present invention.

FIG. 2—Is a typical arrangement of the optical fiber bundle assembly

FIG. 3—A detailed construction of the front side of the optical fiber bundle assembly

FIG. 4—The backside of the small-core optical fiber bundle within the optical fiber bundle assembly

FIG. 5—Shows a basic embodiment for the first configuration of the present invention

FIG. 6—Is the mechanical embodiment of the second configuration for the present invention.

FIG. 7—Shows a basic embodiment for the second configuration of the present invention

### DETAILED DESCRIPTION OF THE INVENTION

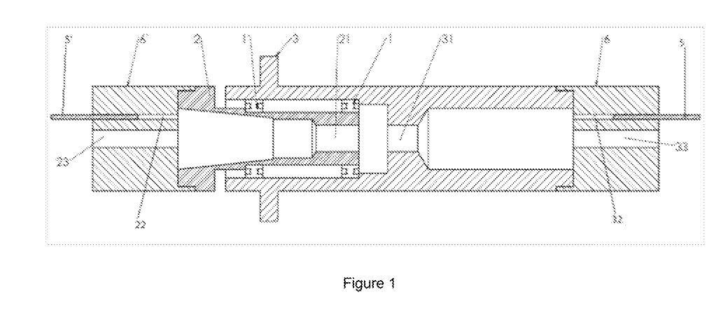

FIG. 1 shows a mechanical embodiment for the first configuration of the present invention consists of a rotatable component (2) with a central hole (21), a fixed component (3) with a central hole (31), a pair of bearing (1) and (1′) to enable the rotatable and fixed components (2) and (3) to be rotated relative to each other. The rotatable component (2) contains fiber holder (6′), which has one off axis coupling hole (22) and a center bore (23). Similarly, the fixed component (3) consists of a fiber holder (6), which has one off axis coupling hole (32) and a center bore (33). Within each coupling hole (22) and (32) there is a large core fiber (5) and (5′) respectively. The axis of the rotation is the geometrical axis of the component (2) and (3). In addition, the centerlines of the center bores (23) and (33) coincide with the axis of rotation.

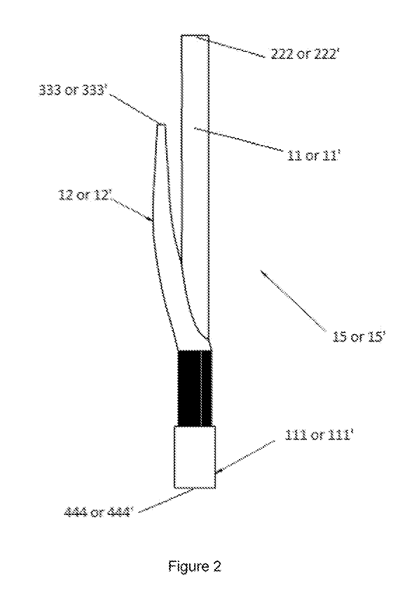

FIG. 2 shows a typical arrangement of the optical fiber bundle assembly (15) and (15′) for the present invention. They have a top (222) and (222′) and a bottom (111) and (111′). The fiber bundle assembly (15 or 15′) includes a group of small-core fibers (12 or 12′) and a center bore (11 or 11′). The group of smaller-core optical fibers (12) and (12′) has a front (444) and (444′) and back (333) or (333′). The front (444) and (444′) of the small-core optical fiber group (12) and (12′) are circumferentially arranged around the peripheral space of the center bore (11) and (11′). The back (333) and (333′) of the small-core optical fiber group (12) and (12′) is arranged with an outer dimension such that it will fit within the coupling hole (22 or 32 in FIG. 1).

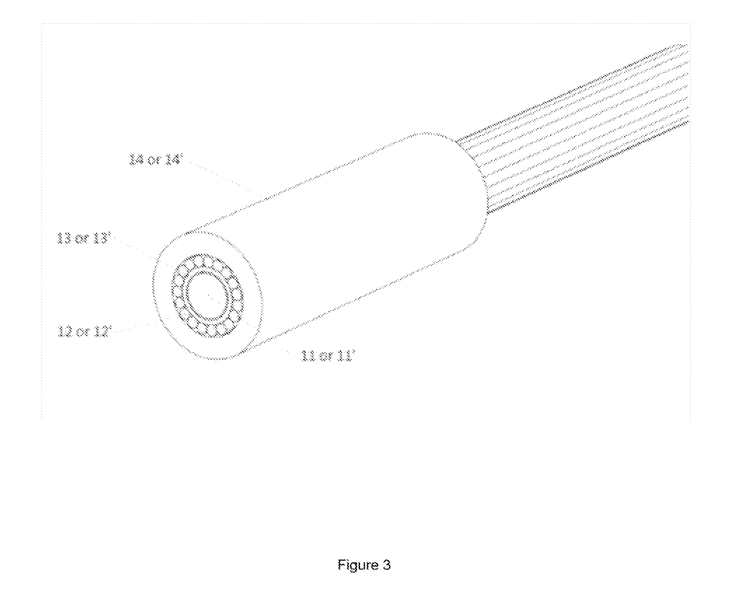

FIG. 3 shows the detailed construction of the front of the optical fiber bundle assembly (444 or 444′ in FIG. 2). In this embodiment, the annular component (13) and (13′) is the outside wall of the center bore 11) and (11′) while the other annular component (14) and (14′) is the holder for the front of the optical fiber bundle assembly (444) and (444′). This is coaxially arranged with the outer wall of the center bore (13) and (13′). The radial clearance between the external diameter of the center bores' (13) and (13′) outer wall and internal diameter of the optical fiber bundle assembly holder (14) and (14′) is equal to the diameter of smaller-core optical fibers (12) and (12′) so that a number of smaller-core optical fibers (12) and (12′) can be circumferentially arranged in the peripheral clearance space.

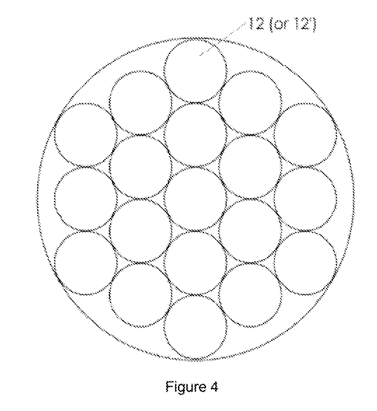

FIG. 4 shows the back (333 or 333′ in FIG. 2) of the small-core optical fiber group (12) or (12′). In this embodiment the small-core optical fibers are arranged into a circle with the same diameter the large core fiber (5 or 5′ in FIG. 1).

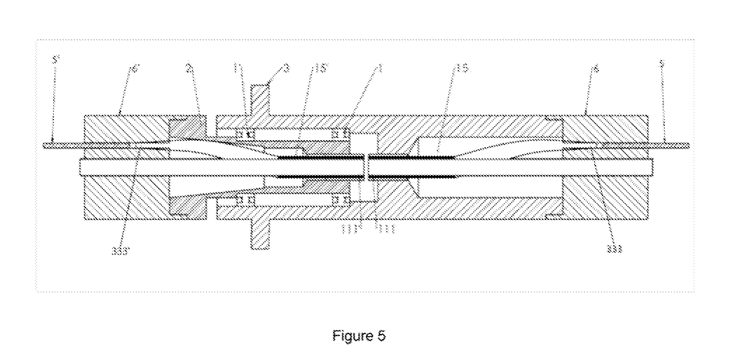

FIG. 5 shows a basic embodiment for the first configuration of the present invention consists of the mechanical embodiment shown in FIG. 1 and two optical fiber bundle assembly (15) and (15′) shown in FIG. 2. The bottom (111) of the first optical fiber bundle assembly (15) is secured in the central hole (31 in FIG. 1) of the fixed component (3), while the back of the first small core optical fiber group (333) is secured in coupling hole (32 in FIG. 1) of the fixed component (3). In addition, the center bore (11 in FIG. 2) of the first optical fiber bundle assembly (15) is secured to and axially aligned with the center bore (33 in FIG. 1) of the fixed fiber holder (6). Similarly, the bottom side (111′) of the second optical fiber bundle assembly (15′) is secured in the central hole (21 in FIG. 1) of the rotatable component (2). The back of the second small core optical fiber group (333′) is secured in the coupling hole (22 in FIG. 1) of the rotatable component (2). In addition, the center bore (11′ in FIG. 2) of the second optical fiber bundle assembly (15′) is secured to and axially aligned with the center bore (23 in FIG. 1) of the rotatable component (2). In both the rotatable and fixed fiber holder (6′) and (6) respectively the backside of the small core optical fibers (333) and (333′) are facing opposite the larger core fibers (5) and (5′) respectively.

The optical signal enters from one of the large-core fibers (5) or (5′) is then coupled to the back of the smaller-core optical fiber bundles (333) or (333′) in the coupling hole (32) or (22) of the fiber holder (6) or (6′). It is then coupled into the front of the other smaller-core optical fiber bundle (444′ or 444 in FIG. 2) of the other optical fiber bundle assembly (15) or (15′) on the other side of the rotatable mechanical interface. Finally from the back of the second smaller-core optical fiber bundle (12′) or (12) is coupled into the other large-core coupling fiber (5′) or (5) in the other coupling hole (22) or (32) of the other fiber holder (6′) or (6).

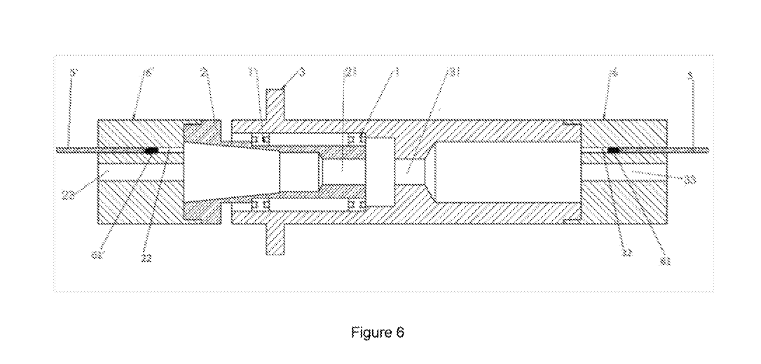

FIG. 6 shows a mechanical embodiment for the second configuration of the present invention. It is the same as the mechanical embodiment of the first configuration shown is FIG. 1 except there is an optical expander/condenser (61′) and (61) in the coupling hole (22) and (32) for both the fixed and rotatable fiber holder (6′) and (6). The optical expanders/condensers (61′) and (61) consist of two optical elements which are either two positive refractors or one positive refractor and one negative refractor.

The first refractor in the optical expander/condenser (61) and (61′) receives the optical signal from the large-core optical fiber or the optical fiber bundle assembly. It then expands or condenses the optical signal respectively. The second refractor receives the optical signal from the first refractor and collimates the signal so it is parallel to a common axis shared by both the large-core optical fiber and the optical fiber bundle assembly. The refractors are chosen based on many factors such as cost, availability and on the design requirements to name a few. However, in general they are chosen such that the ratio of the focal length of the second refractor, to the focal length of the first refractor equals the magnification or de-magnification required to successfully couple the optical signal between the large-core fiber and the optical fiber bundle assembly.

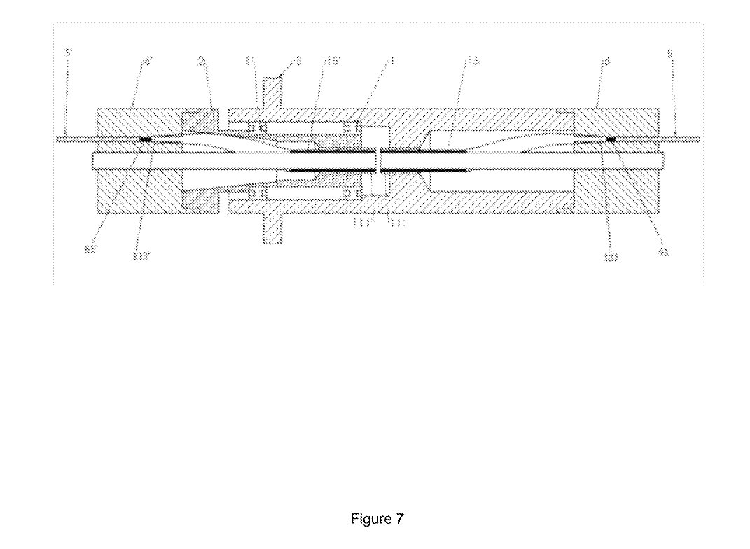

FIG. 7 shows a basic embodiment for the second configuration of the present invention consists of the mechanical embodiment shown in FIG. 6 and two optical fiber bundle assembly (15) and (15′). The bottom (111) of the first optical fiber bundle assembly (15) is secured in the central hole (31 in FIG. 6) of the fixed component (3), while the back of the first small core optical fiber group (333) is secured in coupling hole (32) of the fixed component (3). Similarly, the bottom side (111′) of the second optical fiber bundle assembly (15′) is secured in the central hole (21) of the rotatable component (2), while the backside of the second small core optical fiber group (333′) is secured in coupling hole (22) of the rotatable component (2). In addition, the center bores (11′ and 11 in FIG. 2) of the optical fiber bundle assemblies (15′) and (15) are secured to and axially aligned with the center bores (23 and 33 in FIG. 6) of the rotatable and fixed components (2) and (3). The optical expander/condenser (61 and 61′) within the rotatable and fixed fiber holder (6′) and (6) are both located between the back of the small core optical fiber groups (333 and 333′) and the opposite facing larger core fibers (5 and 5′) respectively.

I claim:

1. A passive off-axis bi-directional fiber optic rotary joint for optic signal transmissions comprising:
a first and a second relatively rotatable body components a common rotary axis containing a central hole;
a first and a second fiber holders each having a center bore and a coupling hole;
a pair of bearings to enable the said body components to rotate relatively;
a first optical fiber bundle assemblies with the bottom being secured in the central hole of the first rotatable body component, while the top is secured by the first rotatable fiber holder; and
a second optical fiber bundle assemblies with the bottom being secured in the central hole of the second rotatable body component, while the top is secured by the second fiber holder.

2. A passive off-axis bi-directional fiber optic rotary joint of claim 1, wherein each of the optical fiber bundle assemblies further comprising:
a center bore;
a group of small-core optical fibers with a front and a back; wherein the small core fibers in said front being circumferentially arranged around the peripheral space of the said front portion of said center bore; and
said back of the group of small-core optical fibers is secured in the coupling hole of the fiber holder which in turn is connected to a large-core optical fiber.

3. The passive off-axis bi-directional fiber optic rotary joint of claim 2, wherein further comprising:
a light path having a first and a second optical fiber bundle assemblies and a first and a second large-core optical fibers; and
a light signal emitted from the first large-core optical fiber will be coupled to the back of a first group of small-core optical fibers in the coupling hole of the first fiber holders, wherein the signal travels through the back of the first group of small-core optical fibers toward the front side, which is then coupled into the front of the second group of small-core optical fibers and finally goes from the back of the second group of small-core optical fibers into the second large-core optical fiber in the coupling hole of the second fiber holder.

4. A passive off-axis bi-directional fiber optic rotary joint for optic signal transmissions comprising:
a first and a second relatively rotatable body components having a common rotary axis each containing a central hole;
a first and a second fiber holders each having a center bore and a coupling hole, wherein an optical expander/condenser is within each coupling hole;
a pair of bearings to enable the said body components to rotate relatively;
a first optical fiber bundle assemblies with the bottom of being secured in the central hole of the first rotatable body component, while the top is secured by the first rotatable fiber holder; and
a second optical fiber bundle assemblies with the bottom being secured in the central hole of the second rotatable body component, wherein the top is secured by the second fiber holder.

5. A passive off-axis bi-directional fiber optic rotary joint of claim 4, wherein one each of the optical fiber bundle assemblies further comprising:
a center bore;
a group of the small-core optical fibers each fiber having a front and a back, wherein the fronts of the small-core optical fibers are circumferentially arranged around the peripheral space of the said front portion of said center bore, and said backs of the group of the small-core optical fibers are secured in the coupling hole of the fiber holder which in turn is connected to a large-core optical fiber opposite a large-core optical fiber.

6. A passive off-axis bi-directional fiber optic rotary joint of claim 5, wherein the optical expanders/condensers is comprised of two positive refractors and are located within the coupling hole between the back of the optical fiber bundle and the large-core optical fiber.

7. The passive off-axis bi-directional fiber optic rotary joint of claim 6, wherein further comprising:
a light path having a first and a second optical fiber bundle assemblies, a first and a second optical expanders/condensers and a first and a second groups of large-core optical fibers; and
a light signal emitted from the first large-core optical fiber will be expanded by the first optical expander/condenser then coupled to the back of a first group small-core optical fibers bundled in one of the coupling hole of one of the said fiber holders, wherein the signal travels through the back of the first group of small core optical fibers toward the front side, which is then coupled into the front of a second group of small-core optical fibers then through the back of the second optical fiber bundle assemblies and the signal is then condensed by the second optical expander/condenser and finally goes into the second large-core optical fiber in the coupling hole of the other fiber holder.

8. A passive off-axis bi-directional fiber optic rotary joint of claim 5, wherein the optical expanders/condensers further comprise one positive and one negative refractor and are located within the coupling hole between the back of the optical fiber bundle and the large core optical fiber.

9. The passive off-axis bi-directional fiber optic rotary joint of claim 8, wherein further comprising:
a light path having a first and a second optical fiber bundle assemblies, a first and a second optical expanders/condensers and a first and a second groups of large-core optical fibers; and
a light signal emitted from the first large-core optical fiber will be expanded by the first optical expander/condenser then coupled to the back of a first group small-core optical fibers bundled in one of the coupling hole of one of the said fiber holders, wherein the signal travels through the back of the first group of small core optical fibers toward the front side, which is then coupled into the front of a second group of small-core optical fibers then through the back of the second optical fiber bundle assemblies and the signal is then condensed by the second optical expander/condenser and finally goes into the second large-core optical fiber in the coupling hole of the other fiber holder.
